(19) United States
(12) Patent Application Publication
(10) Pub. No.: US 2008/0313605 A1
(43) Pub. Date: Dec. 18, 2008

(54) DEVELOPMENT FRAMEWORK FOR AUTOMATED DATA THROUGHPUT OPTIMIZATION

(75) Inventor: Douglas L. Sandy, Chandler, AZ (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/762,965

(22) Filed: Jun. 14, 2007

(51) Int. Cl. G06F 9/44

(52) U.S. Cl. 717/107

(57) ABSTRACT

A method (400) of generating computer program code (108). The method can include receiving an indicator that identifies a desired amount of memory to be used for executing the computer program code. At least one identifier for at least a first algorithm (114,116,118) to be implemented by the computer program code can be received, and a version of the first algorithm that is optimized for the desired amount of memory to be used can be identified. Syntax for the identified version of the algorithm can be combined with syntax of a code template (122).

### BACKGROUND OF THE INVENTION

1. Field of the Invention

The present invention generally relates to data processing and, more particularly, to processing of data contained in an array.

2. Background of the Invention

Computer imaging and machine vision algorithms pose a unique challenge to system engineers. High resolution image feeds generate massive amounts of data that must be processed in short periods of time. Often computation must occur within the inter-frame period of the media, leaving only a fraction of a second for the processing of each image. Nonetheless, while computational and throughput demands remain high, power usage and system cost targets typically are low.

A number of strategies have been proposed to solve this challenge, for example using specialized application specific integrated circuits (ASICs), massively parallel computing networks, and even holographic techniques. Much attention also has been given to the conversion of scalar (non-vector) code to execute on vector processing engines. This work has led to mixed results when applied to actual hardware, however. Much of the expected performance is lost due to the transfer of data between different levels of memory, for example between different levels of cache memory or between cache memory and random access memory.

### SUMMARY OF THE INVENTION

The present invention relates to a method of generating computer program code. The method can include receiving an indicator that identifies a desired amount of memory to be used for executing the computer program code. At least one identifier for at least a first algorithm to be implemented by the computer program code can be received, and a version of the first algorithm that is optimized for the desired amount of memory to be used can be identified. Syntax for the identified version of the algorithm can be combined with syntax of template code.

In another arrangement, the method of generating computer program code can include receiving an indicator that identifies a desired amount of memory to be used for executing the computer program code to process an array, receiving at least one identifier for at least a first algorithm to be implemented by the computer program code, and identifying a version of the first algorithm that is configured to process the array using a particular band size that is selected for the desired amount of memory to be used. The syntax for the identified version of the algorithm can be combined with syntax of a code template.

The present invention also relates to a computer program product including a computer-usable medium having computer-usable program code that, when executed, causes a machine to perform the various steps and/or functions described herein.

### BRIEF DESCRIPTION OF THE DRAWINGS

Preferred embodiments of the present invention will be described below in more detail, with reference to the accompanying drawings, in which:

FIG. 1 depicts a block diagram of a computer code generating tool that is useful for understanding the present invention;

FIG. 2 depicts a graphical user interface view that is useful for understanding the present invention;

FIG. 3 depicts a graphical user interface view that is useful for understanding the present invention;

FIG. 4 is a flow chart presenting a method of generating computer program code that is useful for understanding the present invention; and

FIG. 5 is a flow chart presenting a method of determining an amount of memory that will be required to execute computer program code, which is useful for understanding the present invention.

### DETAILED DESCRIPTION

Arrangements of the present invention relate to a method, a system and a computer program product that generates computer program code which is optimized for use with a desired amount of memory during execution. Such memory can be, for example, cache memory used by a processor that executes the program code. In this regard, the present invention can provide a framework for algorithm development that improves cache efficiency, thereby reducing unwanted data transfers.

The present invention may take the form of an entirely hardware embodiment, an entirely software embodiment, including firmware, resident software, micro-code, etc., or an embodiment combining software and hardware aspects that may all generally be referred to herein as a “circuit,” “module,” or “system.”

Furthermore, the invention may take the form of a computer program product accessible from a computer-usable or computer-readable medium providing program code for use by, or in connection with, a computer or any instruction execution system. For the purposes of this description, a computer-usable or computer-readable medium can be any apparatus that can contain, store, communicate, propagate, or transport the program for use by, or in connection with, the instruction execution system, apparatus, or device.

Any suitable computer-usable or computer-readable medium may be utilized. For example, the medium can include, but is not limited to, an electronic, magnetic, optical, magneto-optical, electromagnetic, infrared, or semiconductor system (or apparatus or device), or a propagation medium. A non-exhaustive list of exemplary computer-readable media can include an electrical connection having one or more wires, an optical fiber, magnetic storage devices such as magnetic tape, a removable computer diskette, a portable computer diskette, a hard disk, a rigid magnetic disk, an optical storage medium, such as an optical disk including a compact disk-read only memory (CD-ROM), a compact disk-read/write (CD-R/W), or a DVD, or a semiconductor or solid state memory including, but not limited to, a random access memory (RAM), a read-only memory (ROM), or an erasable programmable read-only memory (EPROM or Flash memory).

A computer-usable or computer-readable medium further can include a transmission media such as those supporting the Internet or an intranet. Further, the computer-usable medium may include a propagated data signal with the computer-usable program code embodied therewith, either in baseband or as part of a carrier wave. The computer-usable program code may be transmitted using any appropriate medium, including but not limited to the Internet, wireline, optical fiber, cable, RF, etc.

In another aspect, the computer-usable or computer-readable medium can be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

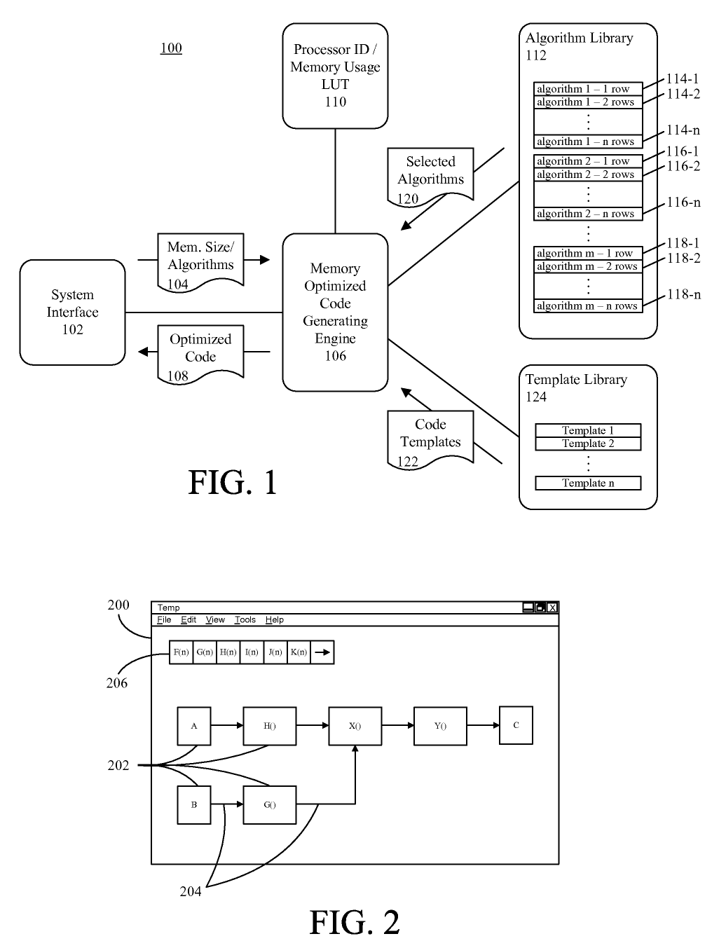

FIG. 1 depicts a block diagram of a computer code generating tool (hereinafter “tool”) 100 that is useful for understanding the present invention. The tool 100 can include a system interface 102. The system interface 102 can interface with a data processing system, such as that previously described, to execute processes described herein. For instance, the system interface 102 can present one or more views on a display of a user interface, receive user inputs via the user interface, send and receive data from I/O devices and/or computer-readable mediums, and so on. For example, via the user interface, the system interface 102 can receive data 104 indicating the desired amount of memory to be used when computer program code generated by the tool 100 is executed. The data 104 also can indicate algorithms to be performed by the computer program code and the order in which the algorithms are to be executed. Further, the data 104 can indicate the nature of data (target data) to be processed by the algorithms. For instance, the data 104 can indicate that the source data comprises one or more arrays, the respective sizes of such arrays, and the number of bytes per element of such arrays. The indicated algorithms can be, for example, algorithms that are optimized for image processing.

Briefly referring to FIG. 2, in one arrangement the system interface can present a view of a graphical user interface (GUI) workspace 200 in which a user can enter algorithm identifier blocks 202 and algorithm connectors 204. The algorithm identifier blocks 202 can correspond to algorithms that are to be implemented by computer program code that is generated by the tool 100. The algorithm connectors 204 can indicate an order in which the algorithms are to be executed within the generated computer program code. A menu of selectable items 206 can be provided to facilitate selection of the algorithm identifier blocks 202 and algorithm connectors 204.

Notwithstanding, although use of a GUI workspace can be convenient to some users, other users may prefer to enter data in another format, for instance using a command prompt, text editor, etc. Accordingly, algorithms to be implemented by the computer code, and the order in which they are to be executed, can be identified in any suitable manner and the invention is not limited in this regard. For example, in one arrangement, a user can generate a source file that identifies the algorithms and execution order.

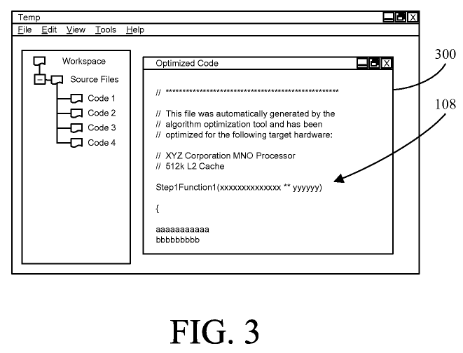

Referring again to FIG. 1, the tool 100 also can include a memory optimized code generating engine (hereinafter “code engine”) 106. The code engine 106 can receive from the system interface 102 the data 104 indicating the desired amount of memory to be used when executing the generated computer program code, as well as the algorithms to be executed, their execution order and the nature of the data to be processed by the algorithms. The code engine 106 can process such data 104 to generate memory optimized computer program code (hereinafter “code”) 108. The code 108 can be communicated to the system interface 102 for transfer to a computer-usable or computer readable medium, presentation to a user, or for any other desired purpose. In one aspect of the inventive arrangements, the code 108 can be presented to the user via a user interface, for instance in a view of a GUI workspace. An example of such a workspace 300 is depicted in FIG. 3.

In one arrangement, the data 104 indicating the desired amount of memory can indicate a value of memory size. In another arrangement, the data 104 can identify a processor to the code engine 106, and the code engine 106 can automatically select the desired amount of memory to be used by the code 108 when executed based on the identified processor. For instance, the data 104 can comprise an identifier associated with a particular processor, and a memory size associated with the identifier can be selected by the code engine 106. To facilitate such selection, a look-up table 110 that associates such identifiers with memory size can be provided. The look-up table 110 can, for example, associate a processor model number to the desired memory size associated with that processor. The look-up table 110 can be implemented as a data table, a data file, or in any other suitable manner.

As noted, the data 104 also can identify the algorithms to be executed by the code 108. Such identification can be implemented using identifiers, such as names, numbers, alphanumeric sequences, binary sequences, or any other suitable identifiers. To generate the code 108, the code engine 106 can access an algorithm library 112 and select one or more algorithms 114, 116, 118 that correspond to the identifiers. Moreover, the code engine 106 can select specific versions of the algorithms 114, 116, 118 that are optimized to process a particular band size (e.g. a maximum number of rows or columns within an array) while not exceeding the desired amount of memory usage. In that regard, the algorithm library 112 can include a plurality of specific versions of each algorithm 114, 116, 118. For instance, for the algorithm 114, the algorithm library 112 can provide a first version 114-1 configured to operate on one row of data at a time, a second version 114-2 configured to operate on two rows of data at a time, and so on through n-rows of data. Similarly, for the algorithm 116, the algorithm library 112 can provide a first version 116-1 configured to operate on one row of data at a time, a second version 116-2 configured to operate on two rows of data at a time, and so on. Selection of the algorithm versions will be described herein in greater detail.

In an arrangement in which the band size is less than the total size of an array that comprises the source data, the algorithm version(s) can be selected such that a plurality of bands within the array can be identified. At run-time, a first band of the array can be processed within the desired amount of memory space to generate a first resultant band. For example, one or more operations can be performed on the data within the first band. When processing of the first band with the selected algorithm versions is complete, the resultant band can be removed from the memory and stored to another location (e.g. removed from cache memory and stored to RAM). Data from a second band of the array then can be transferred into the memory and processed with the selected algorithm versions to generate a second resultant band, which also can be removed after such processing. Data from a third band then can be transferred into the memory for processing, and so on. Accordingly, large amounts of data can be processed using relatively little cache memory.

The code engine 106 can select syntax for the selected algorithm versions 120 and combine such syntax with syntax of one or more code templates 122. In one arrangement, the syntax for the code templates 122 can be received from a code template library 124. The code engine 106 can select the code templates 122 based on the types of algorithms to be inserted, the number of algorithms to be inserted, the order in which the algorithms are to be executed, and/or any other information that may be relevant to template selection.

In other arrangements, rather than selecting syntax for the code templates 122 from a code template library 124, the syntax for the code templates 122 can be generated based on one or more suitable algorithms. For example, the syntax for the code templates 122 can be algorithmically generated based on canonical forms. For example, one or more canonical forms can be elected from a conical form library (not shown), and one or more suitable unit operations can be defined in the conical forms. In such an arrangement, the data 104 can define each such unit operation, as may be specified by the user. Examples of unit operators can include, but are not limited to, addition of one array with another, subtraction of one array from another, thresholding (limiting) an array, and mask-based filtering of an array. These algorithms are known to those skilled in the art.

In another arrangement, the canonical form selected from the library can include base unit operations, but such base unit operations can be augmented by the inclusion of additional unit operations. Again, such additional unit operations can be specified by a user and included in the data 104. The code engine 106 can be configured to recognize the additional unit operations and generate the code templates 122 accordingly.

In still another embodiment, a starting canonical form of a single unit operation can be provided to the user via the user interface. The user then can add unit operations to the starting canonical form as desired. The code engine 106 can be configured to recognize these changes to the starting canonical form and modify the form to generate the syntax for the code template code 122 appropriately.

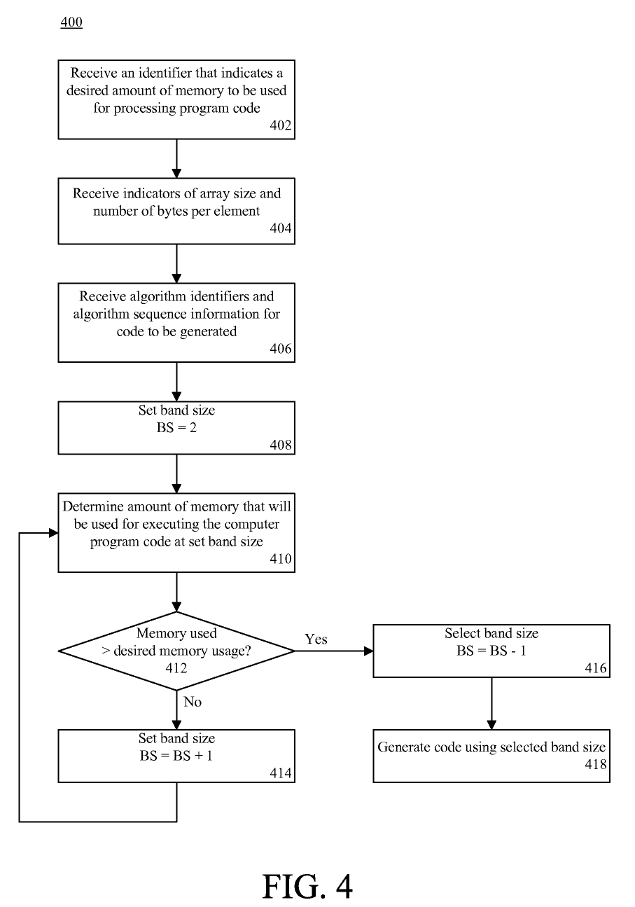

FIG. 4 is a flow chart presenting a method 400 of generating computer program code that is useful for understanding the present invention. At step 402, an identifier can be received that indicates a desired amount of memory to be used for executing computer program code. As noted, the identifier can identify a maximum amount of memory to be used or identify a particular processor for which the computer program is to be optimized. At step 404, indicators can be received that indicate a size of an array of data to be processed by the computer program code, as well as the number of bytes per element within the array. At step 406, algorithm identifiers for algorithms to be implemented by the computer program code, as well as information related to the sequence in which the algorithms should be executed, can be received. Although shown as distinct steps in the flowchart, in other arrangements the information received in steps 402-406 can be received in a single data stream, frame, packet or message, a sequence of data streams, frames, packets or messages, or in other data streams, frames, packets or messages that are recognized as being associated with the same computer program code generating process.

Proceeding to step 408, a band size to be used for banded computation can be set to 2. As used herein, the term “banded computation” means a computation that is performed on a band (e.g. one or more rows or columns) of data within a data array such that the computation may be completed prior to the computation being performed on other rows or columns of the array. At step 410, an amount of memory that will be used for executing computer program code at the set band size can be determined. Such determination can be implemented in any suitable manner, one example of which will be described herein in further detail. As used herein, the term executing computer program code means to execute the computer program code in a compiled form and/or an un-compiled form.

Referring to decision box 412, if the amount of memory that will be used to execute the computer program code does not exceed the desired amount of memory, at step 414 the band size can be incremented by 1. The process then can return to step 410 and the amount of memory that will be used to execute the computer program code at the new band size can be determined. If, however, at decision box 412 it is determined that the amount of memory that will be used to execute the computer program code will exceed the desired amount of memory, the process can proceed to step 416. At step 416, a band size that is one less than the set band size can be selected. The process can continue to step 418 and the syntax of the computer program code can be generated using the selected band size.

In another arrangement, at step 408 the band size to be used for banded computation can be set to a maximum value, for instance to a size that includes all of the rows (or columns) of the array. In this arrangement, at decision box 412 a determination can be made whether the amount of memory that will be used to execute the computer program code will be equal to or less than the desired amount of memory. If not, at step 414, rather than being incremented, the band size (BS) can be decremented by 1. When the appropriate band size is selected such that the amount of memory that will be used to execute the computer program code is equal to or below the desired amount of memory, at step 418 the computer program code can be generated using that band size. In this arrangement, step 416 may be skipped.

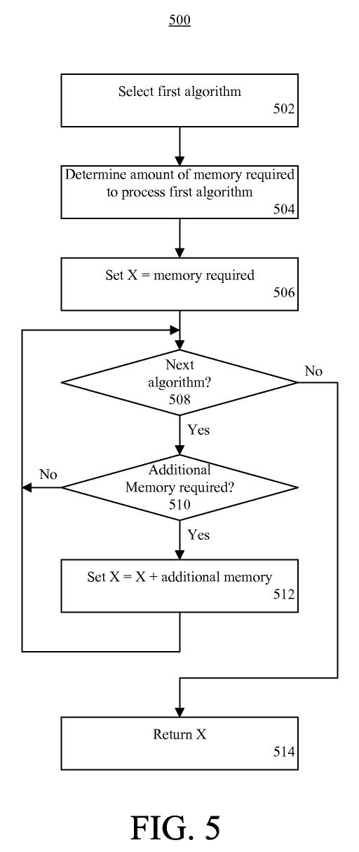

FIG. 5 is a flow chart presenting a method 500 of determining an amount of memory that will be required to execute computer program code, which is useful for understanding the present invention. The method 500 can be implemented at step 410 of the method 400. At step 502, a first algorithm to be implemented in the computer program code can be selected. The version of the first algorithm that is selected can be the version that is configured to operate on the selected band size.

At step 504 the amount of memory required to execute the selected algorithm can be determined. To determine the memory required, a determination can be made to identify the amount of memory required to store the source data, as well as the resultant data if in-place computation is not used. If in-place computation is used for processing the data, the determination of the amount of memory required can be based exclusively on the amount of memory required to store the source data.

The source data can be the data required to process the selected band. For instance, if the algorithm requires only the data from the selected band, the memory required to store the source data can be the memory required to store the selected band. If, however, additional rows and/or columns outside the selected band are required to process the selected band, the source data can be the selected band and the data from the rows and/or columns that are required for processing. By way of example, assume an algorithm for processing a selected row of data requires data from the rows immediately above and below the selected row. Thus, for this example, to process a single row of data may require source data from three rows, to process two rows of data may require four rows of source data, to process three rows of data may require five rows of source data, and so on.

Whether in-place computation is used can be determined by the selected algorithm. As used herein, the term “in-place” computation means a computation that can be performed on data within memory wherein the result of the computation is stored in the memory without requiring additional memory space. For example, for a particular version of an algorithm, an in-place computation can store the result of the algorithm in a same memory region from which the source data processed by the algorithm was retrieved. If the data contains a single set of data, the result can be stored in the location from which the single set of data was retrieved. If the data comprises multiple sets of data, the result can be stored in a location from which one of the source data sets was retrieved, or a plurality of locations from which source data sets were retrieved. For instance, if in-place computation is performed on two source data sets, a portion of the result can be stored in the location from which the first source data set was retrieved and a portion of the result can be stored in the location from which the second source data set was retrieved. In another arrangement, the entire result can be stored in each of the locations.

At step 506, a variable, for example X, can be set to the amount of memory determined at step 504. Proceeding to decision box 508, a determination can be made whether a next algorithm has been selected. Such determination can be based on the data received from the system interface. If there is a next algorithm, at step 510 a determination can be made whether the next algorithm will require an additional amount of memory. For example, a determination can be made whether the next algorithm is implemented using in-place computation, in which case additional memory may not be required. If additional memory is required, at step 512 the additional memory requirement can be determined, as previously described, and added to the selected variable.

Referring again to decision box 508, when it is determined that there are no additional algorithms to be considered, the variable (e.g. X), can be returned to the method 400 to indicate the amount of memory that will be used for executing program code at the set band size.

The flowchart(s) and block diagram(s) in the figures illustrate the architecture, functionality, and operation of possible implementations of systems, methods and computer program products according to various embodiments of the present invention. In this regard, each block in the flowchart(s) or block diagram(s) may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagram(s) and/or flowchart illustration(s), and combinations of blocks in the block diagram(s) and/or flowchart illustration(s), can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the terms “a” and “an,” as used herein, are defined as one or more than one. The term “plurality,” as used herein, is defined as two or more than two. The term “another,” as used herein, is defined as at least a second or more. The terms “including,” “having,” “comprises” and/or “comprising,” as used herein, specify the presence of stated features, integers, steps, operations, elements, and/or components, but do not preclude the presence or addition of one or more other features, integers, steps, operations, elements, components, and/or groups thereof.

The terms “computer code,” “computer program,” “computer program code,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a MIDlet, a source code, an object code, a shared library/dynamic load library and/or other sequence of instructions designed for execution on a processing system.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to the embodiments thereof, it will be apparent that modifications and variations are possible without departing from the scope of the invention defined in the appended claims.

What is claimed is:

1. A method of generating computer program code, comprising:
receiving an indicator that identifies a desired amount of memory to be used for executing the computer program code;
receiving at least one identifier for at least a first algorithm to be implemented by the computer program code;
identifying a version of the first algorithm that is optimized for the desired amount of memory to be used; and
combining syntax for the identified version of the algorithm with syntax of a code template.

2. The method of claim 1, wherein the first algorithm processes data contained in an array.

3. The method of claim 2, wherein identifying the version of the first algorithm comprises determining an amount of the memory anticipated to be required for the version of the first algorithm to process the data contained in an array.

4. The method of claim 3, wherein determining the amount of memory comprises identifying a band size that is to be used for banded computation.

5. The method of claim 3, wherein identifying the version of the first algorithm comprises:
selecting from a plurality of versions of first algorithm at least a first version anticipated to require less than the desired amount of memory to execute the computer program code.

6. The method of claim 3, further comprising:
identifying at least a second version of the algorithm if the amount of memory anticipated to be required for the first version to process the data contained in an array is above the desired amount; and
determining an amount of the memory anticipated to be required for the second version to process the data contained in an array.

7. The method of claim 1, wherein the syntax of the first algorithm tangibly embodies instructions executable by a machine to perform banded computation.

8. The method of claim 1, wherein the syntax of the first algorithm tangibly embodies instructions executable by a machine to perform method steps for processing data contained in an array, said method steps comprising:
identifying a first band in the array, the first band comprising at least a first row of data;
performing a first operation on the first band;
performing at least a second operation on the first band to generate a first resultant band;
identifying a second band in the array, the second band comprising at least a second row of data;
after the first resultant band has been generated, performing the first operation on the second band;
performing the at least a second operation on the second band to generate a second resultant band; and
outputting the first and second resultant bands.

9. The method of claim 8, wherein the identified syntax tangibly embodies instructions executable by a machine to perform in-place computation.

10. A method of generating computer program code, comprising:
receiving an indicator that identifies a desired amount of memory to be used for executing the computer program code to process an array;
receiving at least one identifier for at least a first algorithm to be implemented by the computer program code;
identifying a version of the first algorithm that is configured to process the array using a particular band size that is selected for the desired amount of memory to be used; and
combining syntax for the identified version of the algorithm with syntax of a code template.

11. The method of claim 10, wherein identifying the version of the first algorithm comprises:
selecting from a plurality of versions of the first algorithm at least a first version anticipated to require less than the desired amount of memory to process the computer program code.

12. A program storage device readable by a machine, tangibly embodying a program of instructions executable by the machine to perform method steps for generating computer program code, said method steps comprising:
receiving an indicator that identifies a desired amount of memory to be used for executing the computer program code;
receiving at least one identifier for at least a first algorithm to be implemented by the computer program code;
identifying a version of the first algorithm that is optimized for the desired amount of memory to be used; and
combining syntax for the identified version of the algorithm with syntax of a code template.

13. The program storage device of claim 12, wherein the first algorithm processes data contained in an array.

14. The program storage device of claim 13, wherein identifying the version of the first algorithm comprises determining an amount of the memory anticipated to be required for the version of the first algorithm to process the data contained in an array.

15. The program storage device of claim 14, wherein determining the amount of memory comprises identifying a band size that is to be used for banded computation.

16. The program storage device of claim 14, wherein identifying the version of the first algorithm comprises:
selecting from a plurality of versions of the first algorithm at least a first version anticipated to require less than the desired amount of memory to execute the computer program code.

17. The program storage device of claim 14, said method steps further comprising:
identifying at least a second version of the algorithm if the amount of memory anticipated to be required for the first version to process the data contained in an array is above the desired amount; and
determining an amount of the memory anticipated to be required for the second version to process the data contained in an array.

18. The program storage device of claim 12, wherein the syntax of the first algorithm tangibly embodies instructions executable by a machine to perform banded computation.

19. The program storage device of claim 12, wherein the syntax of the first algorithm tangibly embodies instructions executable by a machine to perform method steps for processing data contained in an array, said method steps comprising:
identifying a first band in the array, the first band comprising at least a first row of data;
performing a first operation on the first band;
performing at least a second operation on the first band to generate a first resultant band;
identifying a second band in the array, the second band comprising at least a second row of data;
after the first resultant band has been generated, performing the first operation on the second band;
performing the at least a second operation on the second band to generate a second resultant band; and
outputting the first and second resultant bands.

20. The program storage device of claim 19, wherein the identified syntax tangibly embodies instructions executable by a machine to perform in-place computation.
